(19) United States
(12) Patent Application Publication
(10) Pub. No.: US 2006/0222842 A1
(43) Pub. Date: Oct. 5, 2006

(54) Polyolefin foam composite material

(75) Inventors: John C. Thezier, Clovis, CA (US); Daniel R. Melton, Fresno, CA (US); James J. Peterson, Oakland, CA (US); Shau-Tarng Lee, Oakland, NJ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 11/094,935

(22) Filed: Mar. 31, 2005

(51) Int. Cl. B32B 27/00

(52) U.S. Cl. 428/319.3; 428/319.7; 428/316.6; 442/30; 442/56

(57) ABSTRACT

A composite material suitable for forming a recreational device, such as a snowboard or bodyboard includes a polyolefin foam base layer, a printed layer overlying the foam base layer, and a top layer overlying the printed layer, and wherein the layers are bonded together in the absence of adhesives. The composite material is produced by positioning a printed layer over a surface of a polyolefin foam base layer and extruding a top layer onto the printed layer with sufficient heat energy that the layers are fusion bonded together in the absence of adhesives to form a composite material. The printed layer comprises a thermoplastic polymeric film having a layer of printing on at least one of its surfaces. This film is fusion bonded to the foam base layer. The top layer comprises an extrusion coating of a transparent thermoplastic polymer that is fusion bonded to the printed layer.

### BACKGROUND OF THE INVENTION

The present invention relates to a multilayer composite material that has a graphic image visible on a surface thereof and to a method for making such a composite material. More particularly, the invention relates to a composite material that includes a foam base layer and a printed layer adhered to the foam base layer to provide the desired graphic image. The composite material may additionally include a transparent protective top layer or skin overlying the printed layer, with the graphic image being visible through this top layer. Composite materials of this type are useful in a variety of applications. For example, they may be used in various outdoor recreational articles such as snowboards, snow sleds, bodyboards, surfboards, cushions, personal flotation devices, etc.

Recreational articles of this type have typically been produced from closed-cell polyethylene foam. Polyethylene is an inert polymer and requires special surface treatment, such as corona treatment, to obtain good adherence of printing ink. For this reason, it is impractical to apply a graphic image to the foam by printing directly onto the foam. Instead, it is more convenient to surface-treat a polyethylene film for ink application, print the graphic pattern onto the surface-treated film, and in turn, laminate the printed film to the polyethylene foam. Another practice is to laminate the printed polyethylene film to another film layer that forms a protective top layer or skin, and then to laminate this composite to the foam. These approaches have required multiple lamination steps to bond the printed film to the foam base layer and to provide a protective top layer or skin.

Schneider et al. U.S. Pat. No. 5,211,593 describes a system for applying a graphics imprinted skin to a foam base layer wherein the graphic image is reverse printed onto a transparent polyethylene film. The printed surface of this film is adhesively laminated to an opaque backing layer to produce a multilayer film structure. The backing layer of this multilayer film structure is then laminated to the foam substrate so that the transparent polyethylene film layer serves as a protective top layer for the printing. This approach is limited by the fact that it requires several lamination steps and results in a structure with adhesive interfaces that may negatively affect the aesthetics of the printing and provide opportunities for delamination.

### BRIEF SUMMARY OF THE INVENTION

The present invention provides a composite material and method wherein a printed layer and protective top layer or skin can be applied to foam base layer quickly and efficiently in a single operation, without requiring adhesive or multiple lamination steps. The composite material includes a polyolefin foam base layer, a printed layer overlying the foam base layer, and a top layer overlying the printed layer, and wherein the layers are bonded together in the absence of adhesives. By eliminating the requirement for an adhesive to bond the printed layer to the other layers, a simpler and more efficient process is achieved and the aesthetics of the printing or graphics are enhanced.

More particularly, according to the present invention, the layers are fusion bonded together. By the term “fusion bonded” it is meant that the layers are bonded directly to one another without an adhesive by fusing the polymer materials of the layers to one another. This is achieved by causing surface portions of the layers to soften or at least partially melt and subsequently to harden or resolidify while in contact so that they become fused. The softening is typically achieved by heating, but could be achieved in other ways, such as by application of ultrasonic energy.

The composite material is produced by positioning a printed layer over a surface of a polyolefin foam base layer and extruding a top layer onto the printed layer with sufficient heat energy that the layers are fusion bonded together in the absence of adhesives to form a composite material.

The printed layer comprises a thermoplastic polymeric film having outer and inner surfaces and a layer of printing on at least one of these surfaces. This film is fusion bonded to the foam base layer. The top layer comprises an extrusion coating of a transparent thermoplastic polymer that is fusion bonded to the printed layer.

Preferably, the thickness of the top layer is such that the ratio of the top layer thickness to the printed layer thickness is at least 6:1. This assures heat energy from the extrusion coated molten thermoplastic polymer top layer can transfer through the thermoplastic polymer film of the printed layer and produce fusion bonding between the printed film layer and the foam base layer.

According to one embodiment of the invention the composite material comprises a polyolefin foam base layer and a printed layer overlying the base layer and comprising a polyolefin film with printing on at least one surface thereof. This film is fusion bonded to the polyolefin foam base layer. Overlying the printed layer is a top layer comprising an extrusion coating of a transparent thermoplastic polymer fusion bonded to the printed layer with the printing being visible therethrough.

In accordance with a further embodiment of the invention, the composite material may additionally include a scrim stiffening layer between the base layer and the printed layer, with the printed layer being bonded to the base layer through interstices in the scrim stiffening layer.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a side cross-sectional view of a composite material in accordance with the present invention which has been fabricated into the form of a bodyboard.

FIG. 2 is an enlarged cross-sectional view of a portion of the composite material of FIG. 1.

FIG. 3 is an exploded side cross-sectional view of the composite material.

FIG. 4 is a side cross-sectional view of a composite material in accordance with another embodiment of the present invention.

FIG. 5 is a schematic side cross-sectional view illustrating a method for producing the composite material of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

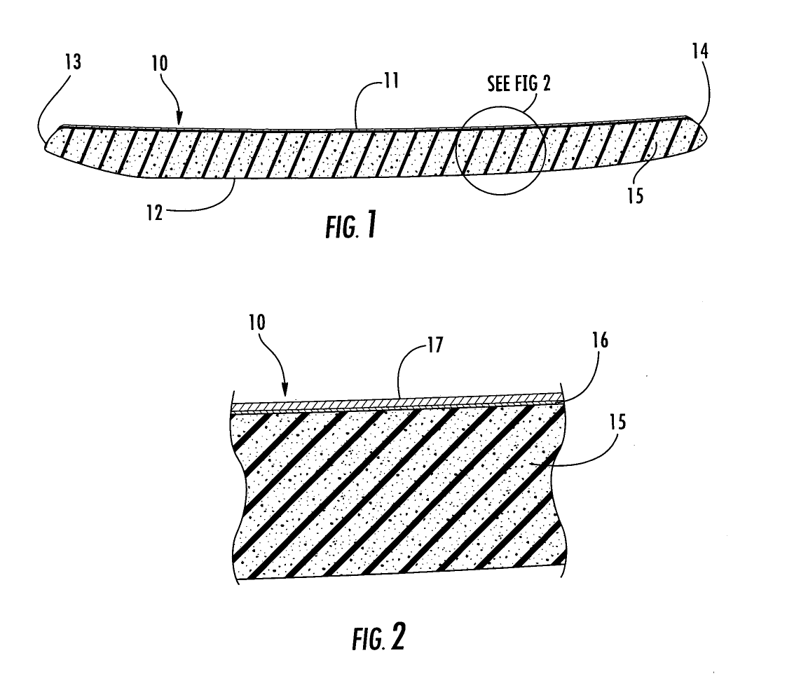

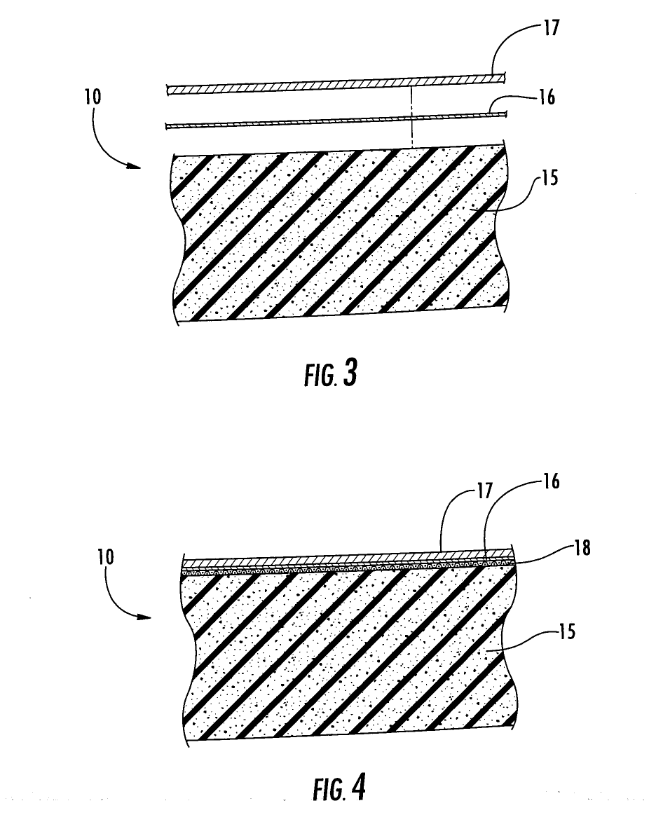

Referring to FIGS. 1 and 2, reference character 10 generally indicates a composite material in accordance with the present invention that has been fabricated into the form of a bodyboard having a top 11, a bottom 12, a front 13 and a rear 14. The composite material 10 includes a foam base layer or core 15 formed of a semi-rigid expanded foam polymer material. The foam base layer may typically have a thickness in the range of from about one inch to about 4 inches and is preferably formed from a closed cell polyethylene foam having a density of from 1 to 10 pounds per cubic foot. As seen at an enlarged scale in FIG. 2, a printed layer 16 overlies the base layer 15 and a protective top layer or skin 17 overlies the printed layer 16 and forms the outermost top surface of the composite material 10.

The printed layer 16 comprises a thermoplastic polymeric film having outer and inner surfaces and a layer of printing on at least one of these surfaces. Preferably, the polymeric film is transparent and the layer of printing is applied to the inner surface facing the base layer 15. The film is preferably a polyolefin polymer or copolymer, and most preferably polyethylene. The film suitably has a thickness in the range of from 1 to 5 mils, preferably about 2 mils. Graphic images are printed on the film using printing processes of the type commonly used for printing on polyethylene films, such as flexographic or gravure printing for example.

The protective top layer or skin 17, sometimes referred to as a “slick skin”, provides the composite material 10 a shiny surface with cushioning characteristics, while also serving to protectively cover the underlying printed layer 16. The top layer 17 is formed of a transparent thermoplastic material so that the underlying printed layer can be seen through the top layer. The top layer 17 is preferably a thermoplastic polyolefin, and more preferably an ethylene polymer, copolymer or blend. Examples of suitable such materials include linear low density polyethylene, high density polyethylene, ethylene vinyl acetate copolymer, acrylic acetate copolymer, and ionic copolymers (or ionomers) such as Surlyn®. The top layer or skin 17 can comprise a single polymer stratum or multiple strata, e.g. a coextrusion of two or more strata of differing composition. For example the top layer 17 may be formed entirely of polyethylene, or it may be a coextrusion including polyethylene on one surface (e.g. the outside surface) and an ethylene acid copolymer or ionomer such as Surlyn®, a product of DuPont, on the opposite surface to provide for enhances bonding. For certain aesthetic effects, the top layer 17 may be colored or tinted. The top layer 17 is thicker than the underlying printed layer 16, and preferably has a thickness at least several times that of the printed layer. The overall thickness of the top layer 17 is preferably from about 15 to 25 mils, and more preferably about 20 mils.

In producing the composite material 10, a printed layer 16 is first produced by imprinting a film with the desired graphics pattern using conventional film printing processes as described earlier. This printed layer is then positioned over a surface of the polyolefin foam base layer 15. Preferably, when the film layer is a transparent film, the layer of printing is oriented facing toward the base layer 15. As shown schematically in FIG. 5, the thermoplastic polyolefin resin of the top layer 17 is heated to a molten state in the barrel of an extruder 20 and the molten resin is extruded from a slot-shaped extrusion die 21 directly onto the exposed surface of the printed layer 16.

The heat energy of the extruded molten resin transfers through the printed layer, heating the printed layer 16 and upper surface portions of the underlying foam base layer 15 sufficiently that the polymer materials soften and fuse together, creating a thermal fusion bond between the printed layer 16 and the foam base layer 15. The thus produced thermal fusion bond does not smear or otherwise adversely affect the aesthetics of the printing.

The thickness of the extrusion coated top layer 17 is controlled by the size of the opening of the slot shaped extrusion die. Preferably, the thickness of the top layer 17 is controlled so that the ratio of the top layer thickness to the thickness of the film of the printed layer 16 is at least 6:1 and more preferably at least 8:1. This assures that sufficient heat energy is present to produce a strong fusion bond at the interface between the printed layer 16 and the foam base layer 15.

As the extrusion coated top layer 17 cools, the molten polymer solidifies on the upper surface of the printed layer 16 and forms a strong fusion bond between the top layer and the printed layer. The top layer 17 may be contacted by an optional chill roll 22 (FIG. 5) which serves to hasten the cooling and hardening of the top layer, and which can also be used to control the surface texture of the top layer. A polished smooth-surfaced chill roll will impart a glossy smooth surface to the top layer 17. If a textured surface is desired, e.g. for providing a non-slip surface, the chill roll surface can be engraved with an appropriate texture.

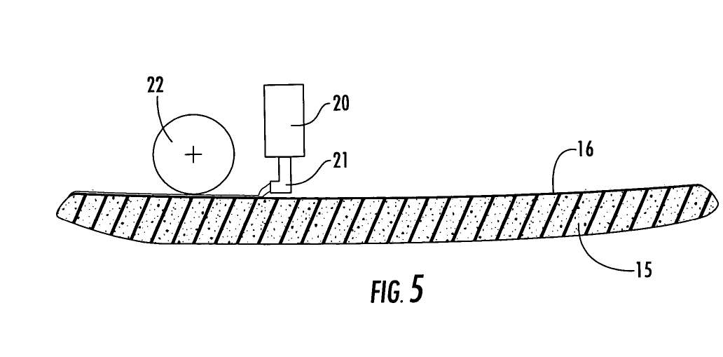

The composite material 10 may also include layers in addition to the printed layer 16 and the top layer 17. In the embodiment shown in FIG. 4, a stiffening layer 18 is provided between the printed layer 16 and the top surface of the foam base layer 15. The stiffening layer 18 may comprise a woven or nonwoven mesh or scrim made of polypropylene, nylon, acrylonitrile-butadiene-styrene (ABS), or some other suitable material, as described for example in U.S. Pat. No. 5,295,883. The stiffening layer 18 is sufficiently open or porous that it allows the printed layer 16 to be fusion bonded to the foam base layer 15 through interstices present in the stiffening layer. Conventional woven or knitted scrim fabrics have a high degree of openness and may be suitably employed.

Although not illustrated, it will be understood that additional layers of various materials may also be provided on the bottom side 12 of the foam base layer 10 to control the stiffness, durability or surface characteristics of the composite material 10.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite material comprising
a polyolefin foam base layer;
a printed layer overlying said base layer; and
a top layer overlying said printed layer;
wherein the layers are bonded together in the absence of adhesives.

2. The composite material of claim 1, wherein said printed layer comprises a thermoplastic polymeric film having outer and inner surfaces and a layer of printing on at least one of said surfaces, said film being fusion bonded to said foam base layer.

3. The composite material of claim 2, wherein said top layer comprises an extrusion coating of a transparent thermoplastic polymer fusion bonded to said printed layer.

4. The composite material of claim 3, wherein the ratio of the top layer thickness to the printed layer thickness is at least 6:1.

5. The composite material of claim 3, wherein said transparent thermoplastic polymer comprises a polyolefin ionomer resin.

6. The composite material of claim 2, wherein said thermoplastic polymeric film comprises a polyethylene film.

7. The composite material of claim 1 further comprising a scrim stiffening layer between any two of the other layers.

8. The composite material of claim 1, wherein the printing on the printed layer is on the side facing the polyolefin foam base layer.

9. A composite material comprising
a polyolefin foam base layer;
a printed layer overlying said base layer and comprising a polyolefin film with printing on at least one surface thereof, said film being fusion bonded to said polyolefin foam base layer; and
a top layer overlying said printed layer and comprising an extrusion coating of a transparent thermoplastic polymer fusion bonded to said printed layer with said printing being visible therethrough.

10. The composite material of claim 9, wherein the ratio of the top layer thickness to the printed layer thickness is at least 6:1.

11. The composite material of claim 9, wherein the ratio of the top layer thickness to the printed layer thickness is at least 8:1.

12. The composite material of claim 9 further comprising a scrim stiffening layer between said base layer and said printed layer.

13. The composite material of claim 9, wherein said thermoplastic polymeric film comprises a polyethylene film and said transparent thermoplastic polymer comprises a polyolefin ionomer resin.

14. A composite material comprising
a polyethylene foam base layer;
a printed layer overlying said base layer and comprising a polyethylene film with printing on at least one surface thereof, said film being fusion bonded to said polyethylene foam base layer;
a scrim stiffening layer between said base layer and said printed layer; and
a top layer overlying said printed layer and comprising an extrusion coating of a transparent thermoplastic polymer fusion bonded to said printed layer with said printing being visible therethrough.

15. A method for producing a composite material suitable comprising:
providing a polyolefin foam base layer;
positioning a printed layer over a surface of the polyolefin foam base layer; and
extruding a top layer onto the printed layer with sufficient heat energy that the layers are fusion bonded together in the absence of adhesives to form a composite material.

16. The method of claim 15, wherein the step of positioning a printed layer comprises positioning a thermoplastic polymeric film having outer and inner surfaces and a layer of printing on at least one of said surfaces over a surface of the foam base layer.

17. The method of claim 16, wherein said step of extruding a top layer comprises extrusion coating a layer of a transparent thermoplastic polymer onto the surface of the printed layer so that the extrusion coating becomes fusion bonded to said printed layer.

18. The method of claim 17, wherein the top layer is extruded onto the printed layer at a thickness such that the ratio of the top layer thickness to the printed layer thickness is at least 6:1.

19. The method of claim 16 including the additional step of positioning a scrim stiffening layer between said foam base layer and said printed layer prior to said extruding step.

20. The method of claim 17 including the additional step, performed after said extruding step, of contacting the extrusion coating with a chill roll.

21. A method for producing a composite material comprising:
providing a polyolefin foam base layer;
positioning a polyolefin film with printing on at least one surface thereof over a surface of said foam base layer, and
extruding a coating of a transparent thermoplastic polymer onto said printed polyolefin film at a thickness sufficient that the heat energy of the coating will cause the polyolefin film to be fusion bonded to the base layer to form a composite material.

22. The method of claim 21, wherein the transparent thermoplastic polymer is extruded onto the polyolefin film at a thickness such that the ratio of the extrusion coating thickness to the polyolefin film thickness is at least 6:1.

23. The method of claim 21 including the additional step of positioning a scrim stiffening layer between said foam base layer and said printed layer prior to said extruding step, and wherein the polyolefin film is fusion bonded to the foam base layer through interstices in the scrim.
